(19) United States
(12) Patent Application Publication
(10) Pub. No.: US 2017/0292436 A1
(43) Pub. Date: Oct. 12, 2017

(54) DIESEL ENGINE

(71) Applicant: MAZDA MOTOR CORPORATION, Aki-gun, Hiroshima (JP)

(72) Inventors: Yoshie Kakuda, Aki-gun, Hiroshima (JP); Daisuke Shimo, Hiroshima-shi (JP); Sangkyu Kim, Higashihiroshima-shi (KR); Hiroshi Minamoto, Hiroshima-shi (JP); Kazuya Niida, Higashihiroshima-shi (JP)

(21) Appl. No.: 15/513,899

(22) PCT Filed: Jun. 5, 2015
(86) PCT No.: PCT/JP2015/002850

§ 371 Date: Mar. 23, 2017

(30) Foreign Application Priority Data
Sep. 30, 2014 (JP) 2014-201173

(51) Int. Cl. F02B 3/06; F02G 5/04; F02D 41/06; F01K 23/14

(52) U.S. Cl. CPC F02B 3/06; F01K 23/14; F02G 5/04; F02D 41/067; F02D 41/068

(57) ABSTRACT

A diesel engine of the present invention includes a turbocharger including: a turbine provided on an exhaust passage; a compressor provided on an intake passage; and a plurality of nozzle vanes provided around the turbine to control a flow velocity of an exhaust gas colliding with the turbine, angles of the nozzle vanes being changeable. In a case where a ratio of a volume of a combustion chamber when the intake valve is closed to a volume of the combustion chamber when a piston is located at a top dead center is denoted by an effective compression ratio εₑ, and a total displacement of the engine is denoted by V (L), the effective compression ratio εₑ is set to satisfy Formula (1) “−0.67×V+15.2≦εₑ≦14.8.”

### TECHNICAL FIELD

The present invention relates to a diesel engine configured to combust a fuel by self-ignition, the fuel being injected from an injection device to a combustion chamber.

### BACKGROUND ART

Various studies have been conducted for making a combustion mode of a diesel engine more appropriate, and known as one example is a technology in which ignition delay (i.e., a time from when a fuel is injected until when the fuel is ignited) of a fuel injected into a cylinder is estimated, and an ignition system is controlled based on the estimated ignition delay.

For example, PTL 1 below discloses that: in a diesel engine, actual ignition delay calculated based on an intake amount, an EGR gas amount, a fuel injection amount, an intake temperature, intake pressure, and the like is compared with ignition delay (reference ignition delay) during a reference driving, the reference ignition delay being calculated from an engine revolution speed and the fuel injection amount by using a map; and a fuel injection timing is corrected based on a difference between the actual ignition delay and the reference ignition delay.

### CITATION LIST

### Patent Literature

PTL 1: Japanese Laid-Open Patent Application Publication No. 2012-87743

### SUMMARY OF INVENTION

### Technical Problem

In the case of a diesel engine mounted on a vehicle, practical problems such as combustion stability (ignitability) during a cold state need to be sufficiently considered. Therefore, a compression ratio is typically set to a relatively high value. For example, in most of diesel engines currently on the market, a geometrical compression ratio is 16 or more. In such conventional diesel engines, even if an injection timing is controlled precisely as in PTL 1, dealing with exhaust gas regulation which is becoming severer in recent years is difficult unless an advanced exhaust gas purifying system specific to a diesel engine is adopted. Specifically, in conventional diesel engines, an increase in a combustion temperature due to the high compression ratio leads to generation of NOx. Therefore, an expensive NOx catalyst which reduces NOx by using urea water or the like needs to be provided. This is one factor which increases a manufacturing cost of the diesel engine.

The present invention was made in view of the above circumstances, and an object of the present invention is to provide a diesel engine which does not require a NOx catalyst and has excellent combustion stability.

### Solution to Problem

To solve the above problems, a first aspect of the present invention in the present application is a diesel engine configured to combust a fuel by self-ignition, the fuel being injected from an injection device into a combustion chamber, the diesel engine including a turbocharger, the turbocharger including: a turbine provided on an exhaust passage so as to be rotatable; a compressor provided on an intake passage so as to be rotatable in conjunction with the turbine; and a plurality of nozzle vanes provided around the turbine to control a flow velocity of an exhaust gas colliding with the turbine, angles of the nozzle vanes being changeable, wherein in a case where a ratio of a volume of the combustion chamber when an intake valve is closed to a volume of the combustion chamber when a piston is located at a top dead center is denoted by an effective compression ratio εₑ, and a total displacement of the engine is denoted by V (L), the effective compression ratio εₑ is set to satisfy Formula (1) “−0.67×V+15.2≦εₑ≦14.8.”

According to the diesel engine of the first aspect of the present invention, since the effective compression ratio εₑ is set to 14.8 or less, combustion is started in a state where air and the fuel are mixed adequately, and a combustion temperature is suppressed low. With this, the amount of NOx generated by the combustion becomes adequately small, so that a special catalyst or the like which treats NOx is not provided on the exhaust passage, and the amount of NOx discharged can be suppressed to an adequately low level.

However, if the effective compression ratio εₑ is set to be too low, in a situation where the temperature of a wall surface of the cylinder is low, and the amount of heat generated is small, especially during a no-load operation (idling) under a cold condition, a cylinder internal circumstance (temperature and pressure) capable of igniting the fuel may not be realized, and misfire may occur in the worst case. On the other hand, according to the first aspect of the present invention, the effective compression ratio εₑ is set to “−0.67×V+15.2” or more in relation to the total displacement V, and the engine includes the turbocharger (so-called variable geometry turbocharger) in which the nozzle vanes are provided around the turbine. Therefore, in an operating condition, such as a cold and no-load state, where it is difficult to secure ignitability, the flow velocity of the exhaust gas is increased by using the nozzle vanes (by reducing a vane opening degree). With this, cylinder internal pressure can be increased by adequately bringing out supercharging performance, and this can improve the ignitability. Thus, regardless of the operating condition, the fuel can be surely ignited, and the adequate combustion stability can be secured.

It is preferable that in the first aspect of the present invention, the turbocharger be configured such that in a case where an opening degree of the nozzle vane when the adjacent nozzle vanes are closed to contact each other is regarded as 0%, and the opening degree of the nozzle vane when the nozzle vanes are opened at maximum is regarded as 100%, the opening degree of the nozzle vane is allowed to be reduced to less than 10% at minimum during an operation of the engine.

As above, when the vane opening degree can be reduced to less than 10%, the flow velocity of the exhaust gas colliding with the turbine can be adequately increased, so that the ignitability of the fuel can be surely improved, and the high combustion stability can be secured.

A second aspect of the present invention in the present application is a diesel engine configured to combust a fuel by self-ignition, the fuel being injected from an injection device into a cylinder, the diesel engine including: a small turbocharger including a turbine provided on an exhaust passage so as to be rotatable and a compressor provided on an intake passage so as to be rotatable in conjunction with the turbine; and a large turbocharger including a turbine provided on the exhaust passage so as to be rotatable, the turbine being larger than the turbine of the small turbocharger and a compressor provided on the intake passage so as to be rotatable in conjunction with the turbine of the large turbocharger, the compressor being larger than the compressor of the small turbocharger, wherein in a case where a ratio of a volume of a combustion chamber when an intake valve is closed to a volume of the combustion chamber when a piston is located at a top dead center is denoted by an effective compression ratio εₑ, and a total displacement of the engine is denoted by V (L), the effective compression ratio εₑ is set to satisfy Formula (2) “−0.67×V+15.0≦εₑ≦14.8.”

According to the diesel engine of the second aspect of the present invention, the effective compression ratio εₑ is set to 14.8 or less. Therefore, as with the first aspect of the present invention, the combustion temperature can be suppressed low, and the amount of NOx generated can be reduced to such a level that the NOx catalyst or the like is not required.

Further, according to the second aspect of the present invention, the effective compression ratio εₑ is set to “−0.67×V+15.0” or more in relation to the total displacement V, and the engine includes two types of turbochargers (so-called two-stage turbocharger) which are different in size from each other. Therefore, under an operating condition, such as a cold and no-load state, where it is difficult to secure the ignitability, supercharging is performed by using the small turbocharger which can operate even by a small amount of exhaust gas. With this, the cylinder internal pressure can be increased by adequately bringing out the supercharging performance, and this can improve the ignitability. Thus, regardless of the operating condition, the fuel can be surely ignited, and the adequate combustion stability can be secured.

It is preferable that in the first or second aspect of the present invention, a concave cavity be formed on a crown surface of the piston, the crown surface opposing to the injection device, and in at least a low-load operation region including a no-load state, the injection device inject the fuel, while dividing the fuel in plural parts, at such timings that at least a part of a spray of the fuel is stored in the cavity.

According to this configuration, a rich air-fuel mixture which is easily ignited can be formed in the cavity. Thus, the ignitability can be effectively improved, and the high combustion stability can be secured. To be specific, in a case where the fuel is injected while being divided in plural parts, the amount of fuel per injection becomes smaller than that in a case where a required amount of fuel is injected once. Therefore, penetration of the spray becomes weak. With this, for example, the spray tends to be accumulated at a specific portion of the cavity. Therefore, although the total injection amount is small, the rich air-fuel mixture can be formed locally, and this can promote the ignition of the fuel.

In the first or second aspect of the present invention, a close timing of the exhaust valve can be set to an advance side of 10° CA after a top dead center.

As above, when the close timing of the exhaust valve is set in the vicinity of the top dead center, internal EGR in which the exhaust gas remains in the combustion chamber hardly occurs, and an effect of increasing the temperature of the combustion chamber by the high-temperature exhaust gas (and the improvement of the ignitability thereby) cannot be expected. However, even under a circumstance where the internal EGR hardly occurs as described above, the diesel engine satisfying the conditions defined in the first or second aspect of the present invention can secure the adequate combustion stability. This means that the same valve timing can be adopted between an operating condition (such as a high-load region) where proper combustion is inhibited if the internal EGR is performed and an operating condition (such as a cold and no-load state) which is severe in terms of the ignitability. Therefore, a changing mechanism for changing, for example, the open and close timings of the exhaust valve is not required, so that the manufacturing cost of the diesel engine can be reduced.

### Advantageous Effects of Invention

As explained above, the present invention can provide a diesel engine which does not require a NOx catalyst and has an excellent combustion stability.

### BRIEF DESCRIPTION OF DRAWINGS

FIG. 1 is a diagram showing an entire configuration of a diesel engine according to Embodiment 1 of the present invention.

FIG. 2 is a partially enlarged cross-sectional view showing an engine main body of the diesel engine.

FIG. 3 is a diagram showing open/close characteristics of intake and exhaust valves of the diesel engine.

FIG. 4 is a partially enlarged cross-sectional view of a piston of the diesel engine.

FIG. 5 is a plan view of the piston.

FIG. 6 is a diagram showing a structure of a turbocharger of the diesel engine in detail.

FIGS. 7A and 7B are diagrams for explaining movements of a variable vane mechanism of the turbocharger. FIG. 7A shows a state where nozzle vanes are fully closed, and FIG. 7B shows a state where the nozzle vanes are opened.

FIG. 8 is a block diagram showing a control system of the diesel engine.

FIG. 9 is a diagram for explaining a mode of a fuel injection performed in an extremely low-load region in the diesel engine.

FIG. 10 is a diagram showing an entire configuration of the diesel engine according to Embodiment 2 of the present invention.

FIG. 11 is a graph showing a condition of an effective compression ratio in relation to a total displacement, the effective compression ratio being necessary to realize both securing of combustion stability and omission of a NOx catalyst.

FIG. 12 is a schematic diagram (Part 1) for explaining details of a study conducted by the present inventors regarding an ignitability index for obtaining conclusions shown in FIG. 11.

FIG. 13 is a schematic diagram (Part 2) for explaining the details of the study regarding the ignitability index.

### DESCRIPTION OF EMBODIMENTS

### (1) Embodiment 1

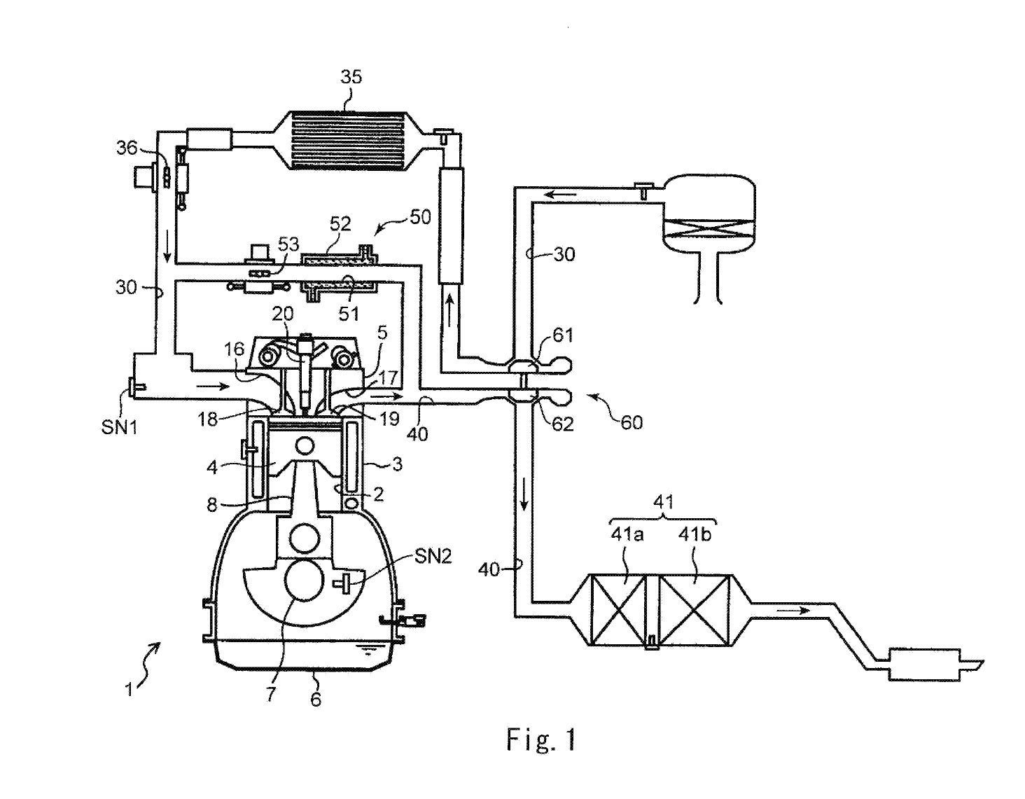

FIG. 1 is a diagram showing an entire configuration of a diesel engine according to Embodiment 1 of the present invention. The diesel engine shown in FIG. 1 is a four stroke four cylinder diesel engine mounted on a vehicle as a power source for traveling. Specifically, this diesel engine includes: an engine main body 1 configured to be driven by supply of a fuel containing light oil as a major component; an intake passage 30 through which air for combustion is introduced to the engine main body 1; an exhaust passage 40 through which an exhaust gas (combustion gas) generated by the engine main body 1 is discharged; an EGR device 50 configured to return a part of the exhaust gas, flowing through the exhaust passage 40, to the intake passage 30; and a turbocharger 60 configured to be driven by the exhaust gas flowing through the exhaust passage 40.

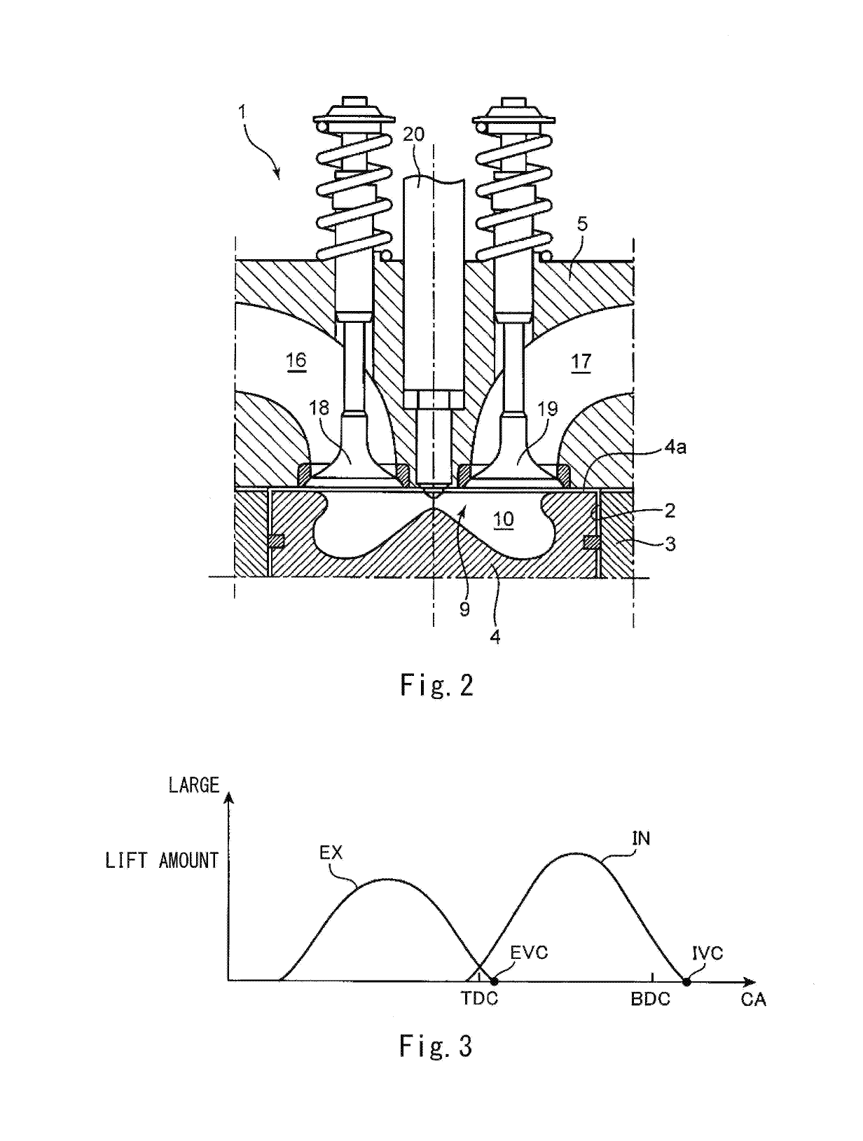

FIG. 2 is a partially enlarged cross-sectional view showing the engine main body 1. As shown in FIG. 2 and FIG. 1 explained as above, the engine main body 1 includes: a cylinder block 3 in which cylindrical cylinders 2 are formed; pistons 4 accommodated in the respective cylinders 2 so as to be able to reciprocate (move upward and downward); a cylinder head 5 provided so as to cover end surfaces (upper surfaces) of the cylinders 2 from a side opposing to crown surfaces 4a of the pistons 4; and an oil pan 6 provided at a lower side of the cylinder block 3 to store lubricating oil. It should be noted that the engine main body 1 of the present embodiment is an inline four cylinder type. Therefore, the engine main body 1 includes four cylinders 2 arranged in a row and four pistons 4. The cylinders 2 and the pistons 4 are arranged so as to be lined up in a direction perpendicular to a paper surface of each of FIGS. 1 and 2 (each of FIGS. 1 and 2 shows only one of the cylinders 2 and only one of the pistons 4.).

The piston 4 is coupled through a connecting rod 8 to a crank shaft 7 that is an output shaft of the engine main body 1. A combustion chamber 9 is formed above the piston 4. In the combustion chamber 9, a fuel injected from a below-described injector 20 combusts by self-ignition. By expansion energy generated by the combustion, the piston 4 reciprocates, and the crank shaft 7 rotates around a central axis thereof.

A total displacement of the engine main body 1 according to the present embodiment, that is, a value obtained by multiplying a displacement of each cylinder 2 (i.e., a volume of a range where the piston moves) by the number of cylinders (in the present embodiment, four) is set to 1.5 L (1,498 cc). Further, a geometrical compression ratio of each cylinder 2, that is, a ratio of a volume of the combustion chamber when the piston 4 is located at a bottom dead center to a volume of the combustion chamber when the piston 4 is at a top dead center is set to 14.80.

The cylinder head 5 is provided with: an intake port 16 through which the air supplied from the intake passage 30 is introduced to the combustion chamber 9; an exhaust port 17 through which the exhaust gas generated in the combustion chamber 9 is discharged to the exhaust passage 40; an intake valve 18 configured to open and close an opening of the intake port 16, the opening being located close to the combustion chamber 9; and an exhaust valve 19 configured to open and close an opening of the exhaust port 17, the opening being close to the combustion chamber 9.

A cavity 10 is formed on the crown surface 4a of the piston 4 in such a manner that a region including a center portion of the crown surface 4a is depressed toward a side (downward) opposite to the cylinder head 5 (see FIG. 2). The cavity 10 is formed such that a volume thereof occupies most of the volume of the combustion chamber 9 when the piston 4 moves upward to be located at the top dead center.

As an injection device configured to inject the fuel to the combustion chamber 9, the injector 20 is attached to the cylinder head 5. The injector 20 is attached coaxially with the cylinder 2 (i.e., a central axis of the injector 20 and a central axis of the cylinder 2 coincide with each other) in such a posture that its end portion (tip end portion) located close to the piston 4 faces a center portion of the cavity 10.

As shown in FIG. 1, the turbocharger 60 includes: a compressor 61 provided at the intake passage 30; and a turbine 62 coaxially coupled to the compressor 61 and provided at the exhaust passage 40. The turbine 62 rotates by energy of the exhaust gas flowing through the exhaust passage 40. The compressor 61 rotates in conjunction with the turbine 62 to compress (supercharge) the air flowing through the intake passage 30.

The EGR device 50 is a device configured to return a part of the exhaust gas, flowing through the exhaust passage 40, as an EGR gas to the intake passage 30. The EGR device 50 includes: an EGR passage 51 that couples the exhaust passage 40 and the intake passage 30; an EGR valve 53 provided at the EGR passage 51 to adjust a flow rate (the amount of EGR gas introduced to the cylinder 2) of the EGR gas flowing through the EGR passage 51; and an EGR cooler 52 configured to cool the EGR gas. It should be noted that in the present embodiment, the exhaust passage 40 provided upstream (upstream in an exhaust gas flow direction) of the turbine 62 and the intake passage 30 provided downstream (downstream in an intake air flow direction) of the compressor 61 are coupled to each other by the EGR passage 51, so that the high-pressure exhaust gas which has not yet flowed through the turbine 62 is returned to the intake passage 30. However, instead of this or in addition to this, the low-pressure exhaust gas which has already flowed through the turbine 62 may be returned to the intake passage 30. In this case, another EGR passage that couples the exhaust passage 40 provided downstream of the turbine 62 and the intake passage 30 provided upstream of the compressor 61 is provided.

An intercooler 35 configured to cool the air compressed by the compressor 61 and an openable/closable throttle valve 36 are provided at the intake passage 30 so as to be located downstream of the compressor 61. It should be noted that basically, the throttle valve 36 is fully open or is maintained at a high opening degree close to full-open during the operation of the engine and is closed to shut off the intake passage 30 when necessary, such as when the engine is in a stop state.

An exhaust gas purifying device 41 configured to purify harmful components in the exhaust gas is provided at the exhaust passage 40 so as to be located downstream of the turbine 62. The exhaust gas purifying device 41 includes: an oxidation catalyst 41a that oxidizes CO and HC in the exhaust gas; and a DPF 41b that collects soot in the exhaust gas. It should be noted that although details will be explained later in “(3) Actions,” the engine of the present embodiment can suppress the amount of NOx generated by the combustion to an adequately small value. Therefore, a catalyst (for example, a catalyst that reduces NOx by using urea water) which treats NOx is not provided at the exhaust passage 40.

FIG. 3 is a graph showing open and close timings of the intake valve 18 and the exhaust valve 19. In this graph, a vertical axis denotes a lift amount, and a horizontal axis denotes a crank angle (CA). Further, “TDC” and “BDC” on the horizontal axis denote the top dead center and the bottom dead center, respectively. Furthermore, a curve shown by “EX” is a lift curve of the exhaust valve 19, and a curve shown by “IN” is a lift curve of the intake valve 18. It should be noted that each of start points and end points of the lift curves, that is, each of the open and close timings of the intake and exhaust valves 18 and 19 corresponds to a timing when the lift amount of the valve is 0.1 mm.

The close timing (shown by “EVC” in FIG. 3) of the exhaust valve 19 is set to an advance side of 10° CA ATDC (after top dead center) (for example, 8° CA ATDC). As above, the exhaust valve 19 is closed immediately after the top dead center. Therefore, in the engine of the present embodiment, a phenomenon in which the high-temperature exhaust gas flows backward from the exhaust port 17 to the combustion chamber 9, that is, internal EGR hardly occurs.

The close timing (shown by “IVC” in FIG. 3) of the intake valve 18 is set to 25° CA ABDC (after bottom dead center). Therefore, in the engine of the present embodiment, an effective compression ratio of each cylinder 2, that is, a ratio of a volume of the combustion chamber when the intake valve 18 is closed to a volume of the combustion chamber when the piston 4 is located at the top dead center is set to 14.45.

In the present embodiment, the above open/close characteristics of the intake and exhaust valves 18 and 19 are constant regardless of an operating condition of the engine. Therefore, in the present embodiment, it is unnecessary to change the open/close characteristics (the open and close timings and the lift amount) of the valve, and a special mechanism for changing the open/close characteristics is also unnecessary. To be specific, a timing changing mechanism configured to change the open and close timings of the intake or exhaust valve, a lift changing mechanism configured to change the lift amount, or the like may be added to a valve mechanism depending on the type of engine. However, such changing mechanisms are not provided at the engine of the present embodiment.

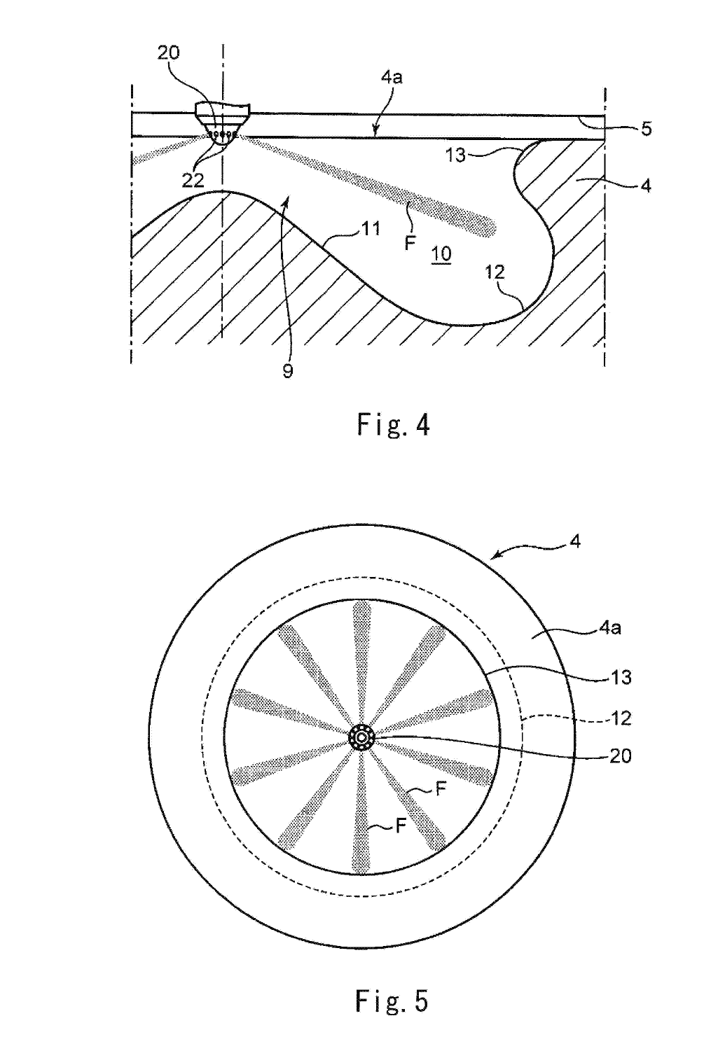

Each of FIGS. 4 and 5 shows a state where the injector 20 injects the fuel toward the cavity 10 provided at the crown surface 4a of the piston 4. As shown in FIGS. 4 and 5, a plurality of (in the present embodiment, ten) injection holes 22 as outlets of the fuel are provided at the tip end portion of the injector 20. The injection holes 22 are arranged so as to be lined up in a circumferential direction at substantially regular intervals. When injecting the fuel, the fuel is injected from the injection holes 22 to form a plurality of sprays F spreading radially in a plan view (see FIG. 5).

The cavity 10 is set to have such a shape and size as to be able to receive the fuel (sprays F) injected from the injector 20 when the piston 4 is located at the top dead center or the vicinity of the top dead center. More specifically, in the present embodiment, the cavity 10 has a so-called reentrant shape. To be specific, a wall surface that forms the cavity 10 includes: a middle protruding portion 11 having a substantially mountain shape; a peripheral concave portion 12 formed at an outer side of the middle protruding portion 11 in a radial direction of the piston 4 and having a circular shape in a plan view; and a lip portion 13 formed between the peripheral concave portion 12 and the crown surface 4a of the piston 4 and having a circular shape in a plan view.

The middle protruding portion 11 is formed such that: a portion thereof closer to the center of the cavity 10 protrudes so as to get closer to the injector 20; and a top portion of this protrusion is located immediately under the tip end portion of the injector 20. The peripheral concave portion 12 is formed so as to be continuous with the middle protruding portion 11 and have a circular-arc shape in a cross-sectional view, the circular-arc shape being concave outward in the radial direction of the piston 4. The lip portion 13 is formed so as to be continuous with the peripheral concave portion 12 and have a circular-arc shape in a cross-sectional view, the circular-arc shape being convex inward in the radial direction of the piston 4.

The cavity 10 configured as above has an upwardly narrowing cross-sectional shape as a whole, that is, an area of an opening of the cavity 10 decreases toward the crown surface 4a of the piston 4. Especially when the amount of fuel injected from the injector 20 is large, the cavity 10 having such shape achieves a function of returning the sprays F of the injected fuel from the outside to the inside (a center side of the cavity 10) in the radial direction mainly along the peripheral concave portion 12 and the middle protruding portion 11. Therefore, the cavity 10 having such shape is advantageous for promoting mixing of the fuel. On the other hand, when the amount of fuel injected is small, the sprays F stay mainly at the peripheral concave portion 12 and its vicinity. Therefore, a rich air-fuel mixture is locally formed, and as a result, ignition (self-ignition) of the fuel is promoted.

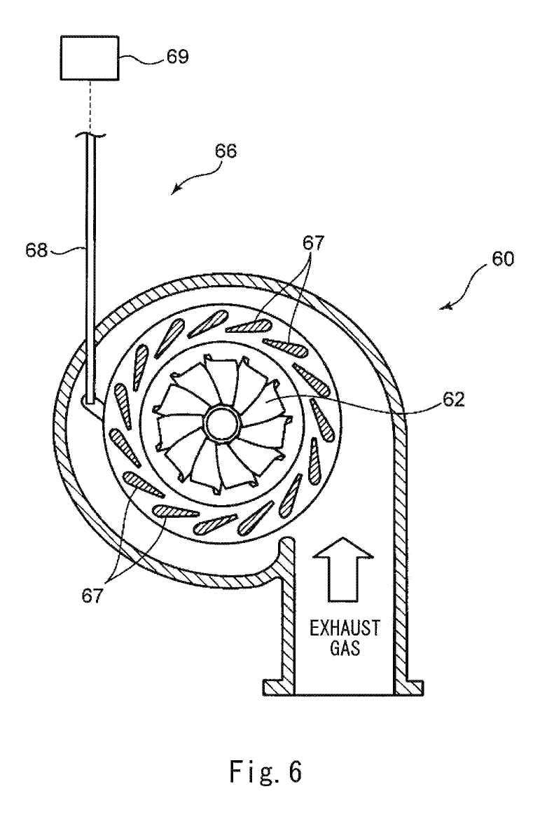

FIG. 6 is a diagram showing a detailed structure of the turbine 62 of the turbocharger 60. As shown in FIG. 6, the turbine 62 of the present embodiment adopts a variable vane mechanism 66 configured to control a flow velocity of the exhaust gas colliding with the turbine 62. To be specific, the turbocharger 60 of the present embodiment is a so-called variable geometry turbocharger (VGT).

The variable vane mechanism 66 includes: a plurality of nozzle vanes 67 provided so as to surround the turbine 62; a rod 68 linked to the nozzle vanes 67; and a vane actuator 69 configured to move the rod 68 forward and backward to change angles of the nozzle vanes 67. When the nozzle vanes 67 are driven in a closing direction (in such a direction that a distance between the adjacent nozzle vanes 67 decreases) by the vane actuator 69 and the rod 68, an area of a passage of the exhaust gas decreases, and the flow velocity of the exhaust gas colliding with the turbine 62 increases. Therefore, even in an operating condition (an engine low-speed region, for example) in which the flow rate of the exhaust gas is low, the turbine 62 can be rotated at high speed, and therefore, supercharging pressure can be increased. In contrast, in an operating condition in which the flow rate of the exhaust gas is high, the flow of the exhaust gas is disturbed if the nozzle vanes 67 are nearly closed. Therefore, the nozzle vanes 67 are driven in an opening direction (in such a direction that the distance between the adjacent nozzle vanes 67 increases) by the vane actuator 69 and the rod 68.

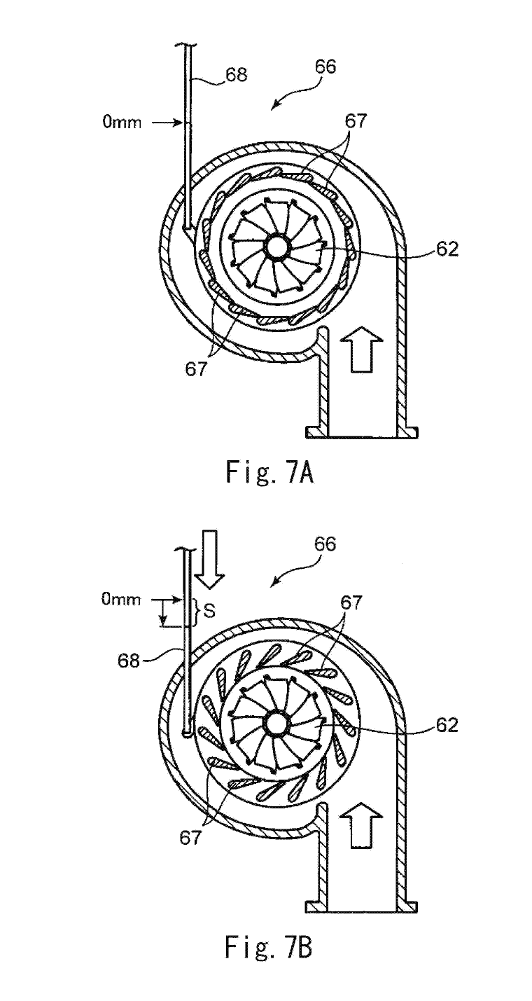

In the present embodiment, a vane opening degree (i.e., an opening degree of each nozzle vane 67) during the operation of the engine can be reduced to less than 10% at minimum, more specifically to 7%. To be specific, as shown in FIG. 7A, a stroke position of the rod 68 when the adjacent nozzle vanes 67 contact each other to completely shut off the passage of the exhaust gas is regarded as 0 mm, and a movement distance (mm) of the rod 68 when the rod 68 moves from the position of 0 mm in such a direction that the nozzle vanes 67 open is regarded as a vane lift S (see FIG. 7B). Further, a maximum value of the vane lift S is denoted by Smax, and a value obtained by a formula “S/Smax×100” is a vane opening degree (%). To be specific, the vane opening degree when the nozzle vanes 67 contact one another is regarded as 0%, and the vane opening degree increases as the nozzle vanes 67 open. The vane opening degree when the nozzle vanes 67 maximally open is 100%. As the vane opening degree decreases, an effect of increasing the flow velocity of the exhaust gas increases. However, when the vane opening degree decreases, an influence on the flow velocity of the exhaust gas by a control error of the vane lift increases. Therefore, the control of the vane lift requires accuracy. In the present embodiment, a high-performance system capable of performing precise control is adopted as a driving system such as the vane actuator 69 and the like, and the vane opening degree during the operation of the engine can be reduced to 7% at minimum.

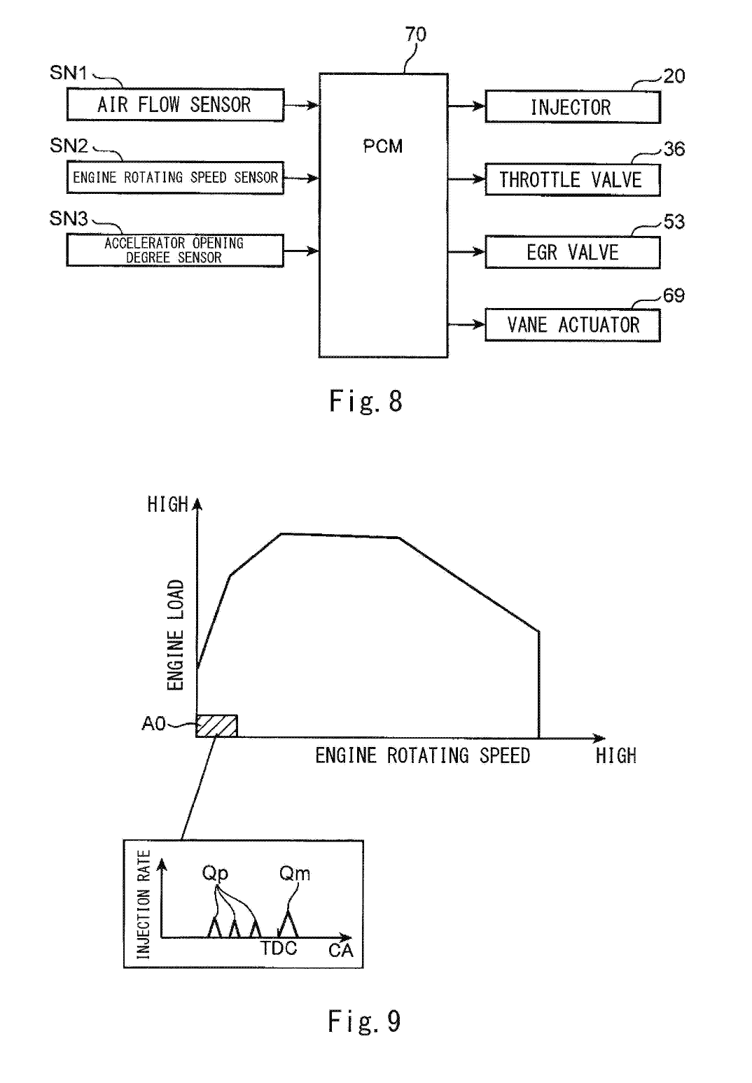

Next, a control system for the engine will be explained by using a block diagram of FIG. 8. As shown in FIG. 8, the diesel engine of the present embodiment is totally controlled by a PCM (Power-train Control Module) 70. As well known, the PCM 70 is a microprocessor constituted by a CPU, a ROM, a RAM, etc.

The PCM 70 is electrically connected to various sensors configured to detect operating states of the engine. To be specific, the engine or the vehicle is provided with various sensors including: an air flow sensor SN1 configured to detect a flow rate (intake air amount) of the air taken in through the intake passage 30; an engine rotating speed sensor SN2 configured to a rotating speed (engine rotating speed) of the crank shaft 7; and an accelerator opening degree sensor SN3 configured to detect an opening degree of an accelerator pedal (not shown) operated by a driver who drives the vehicle. Information pieces detected by the above various sensors are input as electric signals to the PCM 70.

The PCM 70 controls respective portions of the engine while executing various determinations, calculations, and the like based on the input signals from the above various sensors. To be specific, the PCM 70 is electrically connected to respective portions, such as the injector 20, the throttle valve 36, the EGR valve 53, and the vane actuator 69, and outputs drive control signals to these portions based on results of the above calculations and the like.

For example, the PCM 70 successively determines the operating state of the engine based on the signals from the air flow sensor SN1, the engine rotating speed sensor SN2, the accelerator opening degree sensor SN3, etc., and based on the determined operating state, controls the variable vane mechanism 66 of the turbocharger 60, an injection pattern (an injection timing and an injection amount) of the fuel from the injector 20, and the like.

FIG. 9 shows the injection pattern of the fuel in an extremely low-load region A0 set in a low-load low-speed region including a no-load state (an idling state where the accelerator opening degree is zero) of the engine. As shown in FIG. 9, in the extremely low-load region A0 of the engine, the PCM 70 controls the injector 20 such that before and after the compression top dead center (top dead center when a compression stroke terminates), the fuel is injected while being divided in plural parts. Specifically, in the example of FIG. 9, pre-injection Qp is executed three times before the compression top dead center, and main-injection Qm is executed once in the vicinity of the compression top dead center after the pre-injection Qp. Each of the pre-injection Qp and the main-injection Qm is executed at such a timing that at least a part of the fuel (sprays F in FIGS. 4 and 5) injected from the injector 20 is stored in the cavity 10.

During the operation in the extremely low-load region A0, the PCM 70 controls the vane actuator 69 of the turbocharger 60 such that the vane opening degree of the variable vane mechanism 66 becomes a minimum value (in the present embodiment, 7%) of a control range.

### (2) Embodiment 2

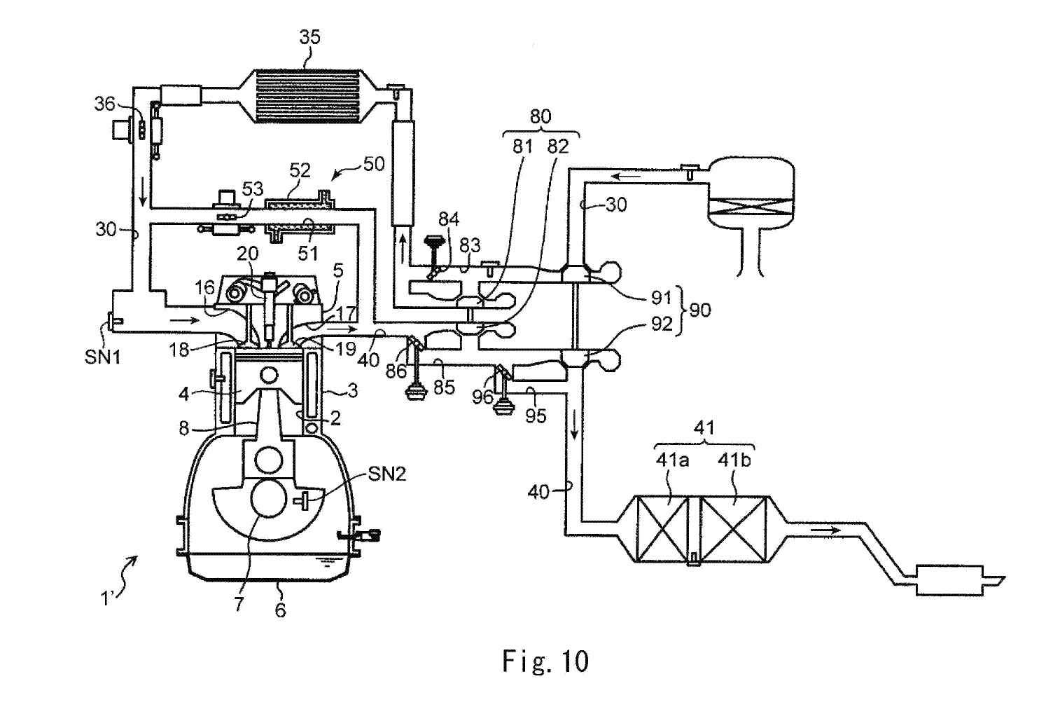

FIG. 10 is a diagram showing an entire configuration of the diesel engine according to Embodiment 2 of the present invention. The diesel engine of Embodiment 2 is the same as the diesel engine of Embodiment 1 except for the specs of the engine main body and the structure of the turbocharger. Therefore, the following will mainly explain the differences from Embodiment 1.

The engine of Embodiment 2 includes an inline four cylinder engine main body 1′ similar to the engine main body of Embodiment 1, but the specs such as the total displacement and the compression ratio are different. Specifically, the total displacement of the engine main body 1′ is 2.2 L (2,188 cc), and the geometrical compression ratio of each cylinder 2 is set to 14.30.

Further, in the engine of Embodiment 2, the close timing of the intake valve 18 is set to 36° CA ABDC (after the bottom dead center), and the effective compression ratio of each cylinder 2 is set to 13.56 based on this close timing of the intake valve 18.

On the other hand, as with Embodiment 1, the close timing of the exhaust valve 19 is set to an advance side of 10° CA ATDC (after the top dead center) (for example, 8° CA ATDC). Further, as with Embodiment 1, a mechanism configured to change the open/close characteristics (the open and close timings and the lift amount) of the intake valve 18 and the exhaust valve 19 is not provided.

As shown in FIG. 10, the engine of Embodiment 2 includes two turbochargers 80 and 90 which are different in size from each other (hereinafter referred to as a small turbocharger 80 and a large turbocharger 90). To be specific, a turbocharger of the present embodiment is a so-called two-stage turbocharger.

A compressor 91 of the large turbocharger 90 is provided on the intake passage 30 so as to be located upstream of a compressor 81 of the small turbocharger 80, and a turbine 92 of the large turbocharger 90 is provided on the exhaust passage 40 so as to be located downstream of a turbine 82 of the small turbocharger 80. Then, the compressor 91 and turbine 92 of the large turbocharger 90 are formed so as to be larger in size than the compressor 81 and turbine 82 of the small turbocharger 80, respectively.

The intake passage 30 is provided with a bypass passage 83 for bypassing the compressor 81 of the small turbocharger 80, and an openable/closable bypass valve 84 is provided on the bypass passage 83.

The exhaust passage 40 is provided with: a bypass passage 85 for bypassing the turbine 82 of the small turbocharger 80; and a bypass passage 95 for bypassing the turbine 92 of the large turbocharger 90. The bypass passages 85 and 95 are provided with openable/closable waste gate valves 86 and 96, respectively.

The bypass valve 84 and the waste gate valves 86 and 96 are controlled such that the small turbocharger 80 and the large turbocharger 90 are selectively used depending on the operating state of the engine. For example, in the engine low-speed region in which the flow rate of the exhaust gas is low, supercharging by the small turbocharger 80 is performed by closing at least the bypass valve 84 and the waste gate valve 86. In contrast, in an engine high-speed region in which the flow rate of the exhaust gas is high, the bypass valve 84 and the waste gate valve 86 are open, and the waste gate valve 96 is closed. With this, in the engine high-speed region, supercharging by the large turbocharger 90 is performed, and supercharging by the small turbocharger 80 is stopped.

Except for the above, the configurations and control details of the engine of Embodiment 2 are basically the same as those of the engine of Embodiment 1. For example, in the engine of Embodiment 2, the fuel injection by the injection pattern similar to the injection pattern shown in FIG. 9 is performed in the low-speed low-load operation region including the no-load (idling) state. To be specific, during the operation in the low-speed low-load region, the PCM 70 causes the injector 20 to inject the fuel by the pre-injection Qp three times and the main-injection Qm once at such timings that at least a part of the fuel (spray F) injected from the injector 20 is stored in the cavity 10 of the piston. It should be noted that since the total displacement of the engine of Embodiment 2 is larger than that of Embodiment 1, a total injection amount of the injector 20 is made larger than that of Embodiment 1.

### (3) Actions

According to each of the diesel engines of Embodiments 1 and 2 explained as above, combustion stability in a low-load region where the fuel injection amount is small (and therefore the ignitability tends to deteriorate) can be adequately secured while reducing the amount of NOx generation to such a level that a NOx catalyst is not required.

To be specific, Embodiment 1 describing the four-cylinder diesel engine having the total displacement of 1.5 L adopts the compression ratios that are extremely low as the compression ratios of the diesel engines, that is, the geometrical compression ratio is 14.80, and the effective compression ratio is 14.45. Similarly, Embodiment 2 describing the four-cylinder diesel engine having the total displacement of 2.2 L adopts the compression ratios that are extremely low as the compression ratios of the diesel engines, that is, the geometrical compression ratio is 14.30, and the effective compression ratio is 13.56. Therefore, in each of the diesel engines of Embodiments 1 and 2, the combustion is started in a state where the air and the fuel are mixed adequately, and the combustion temperature is suppressed low. With this, the amount of NOx generated by the combustion becomes adequately small, so that a special catalyst or the like which treats NOx is not provided on the exhaust passage 40, and the amount of NOx discharged can be suppressed to an adequately low level.

However, in the diesel engine having the low compression ratios as above, in a situation where the temperature of a wall surface of the cylinder 2 is low, and the amount of heat generated is small, especially during a no-load operation (idling) under a cold condition, a cylinder internal circumstance (temperature and pressure) capable of igniting the fuel may not be realized, and misfire may occur in the worst case. To solve these problems, in Embodiment 1, the so-called variable geometry turbocharger (VGT) including the variable vane mechanism 66 is adopted as the turbocharger 60, and the vane opening degree in the extremely low-load region A0 including the no-load state is reduced to less than 10% (specifically, 7%). Therefore, even under a condition where the flow rate of the exhaust gas is originally low, cylinder internal pressure can be increased by adequately bringing out the supercharging performance, and this can improve the ignitability. Further, the two-stage turbocharger constituted by the small turbocharger 80 and the large turbocharger 90 is adopted as the turbocharger in Embodiment 2. During the operation in the extremely low-load region A0, the supercharging is performed by using the small turbocharger 80 which is relatively light in weight (inertia) and can operate even by a small amount of exhaust gas. Therefore, the supercharging performance can be adequately brought out, and this can improve the ignitability. With this, even in a circumstance, such as a cold and no-load state, where it is difficult to perform ignition, the fuel can be surely ignited, and the adequate combustion stability can be secured.

Especially, in Embodiments 1 and 2, during the operation in the extremely low-load region A0, the fuel is injected from the injector 20, while being divided in plural parts, at such timings that at least a part of the spray F is stored in the cavity 10 of the piston 4. Therefore, the rich air-fuel mixture which is easily ignited can be formed in the cavity 10. Thus, the ignitability can be effectively improved, and the high combustion stability can be secured. To be specific, in a case where the fuel is injected while being divided in plural parts (in each of Embodiments 1 and 2, four parts including the pre-injection Qp three times and the main-injection Qm once), the amount of fuel per injection becomes smaller than that in a case where a required amount of fuel is injected once. Therefore, penetration of the spray F becomes weak. With this, for example, the spray F tends to be accumulated at the peripheral concave portion 12 of the cavity 10 and its vicinity. Therefore, although the total injection amount is small, the rich air-fuel mixture can be formed locally, and this can promote the ignition of the fuel.

### (4) Generalization of Conditions

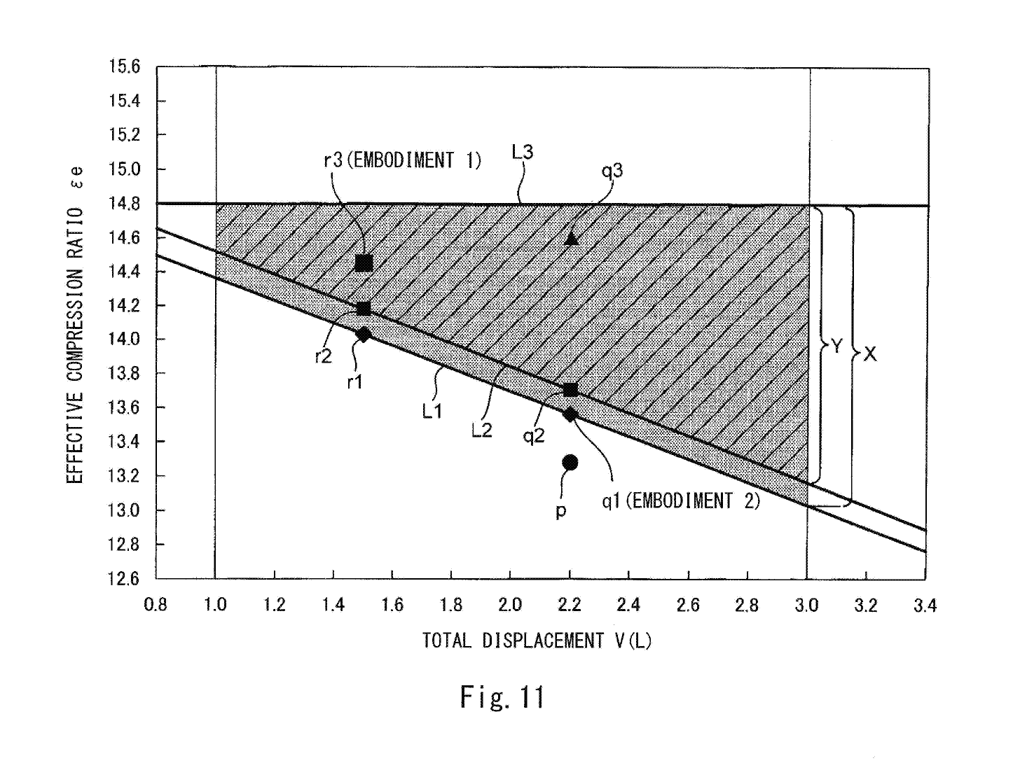

In addition to the diesel engines of Embodiments 1 and 2, the present inventors have further thought about producing various diesel engines having the similar characteristics to those of Embodiments 1 and 2 (i.e., diesel engines which do not require the NOx catalyst and have the excellent combustion stability) and have studied conditions therefor. Then, results shown in FIG. 11 are obtained.

FIG. 11 is a graph showing conditions of an effective compression ratio εₑ and a total displacement V which are necessary to realize the diesel engine having the similar characteristics to those of Embodiments 1 and 2. As explained in Embodiments 1 and 2, the effective compression ratio εₑ is a ratio of a volume of the combustion chamber when the intake valve is closed to a volume of the combustion chamber when the piston is located at the top dead center. The effective compression ratio εₑ is represented by Formula (3) below.

εₑ=1+{(ε−1)/2}→{L+1−cos θ−(L²−sin² θ)^{1/2}} (3)

In Formula (3), ε denotes the geometrical compression ratio, θ denotes an intake valve close timing (deg. BTDC), and L is represented by “connecting rod length/crank radius.”

It should be noted that Formula (3) defining the effective compression ratio εₑ is a formula in a case where a crank shaft center coincides with a cylinder axis. If the crank shaft center is offset relative to the cylinder axis, the effective compression ratio εₑ is represented by Formula (4) below using the offset amount.

εₑ=1+{(ε−1)/2}×[{(L+1)²−e²}^{1/2}−cos(θ+φ)−{L²−(sin(θ+φ)−e)²}^{1/2}] (4)

In Formula (4), e is represented by “offset amount/crank radius,” and φ is represented by “tan⁻¹[e/{(1+L)²=e²}^{1/2}].”

In the graph of FIG. 11, the total displacement V is limited to a range of 1.0 to 3.0 L. This is because the graph is mainly directed to the diesel engines mounted on vehicles (passenger vehicles).

According to the studies by the present inventors, in a case where the effective compression ratio εₑ defined by Formula (3) or (4) is set to a value within a region X or Y shown in FIG. 11 in relation to the total displacement V, both the securing of the combustion stability and the omission of the NOx catalyst can be realized.

Specifically, the regions X and Y shown in FIG. 11 are defined by straight lines L1, L2, and L3. Among these straight lines, the straight line L1 located at a lowermost side shows a lower limit of the effective compression ratio εₑ capable of securing the combustion stability in a case where a two-stage turbocharger (small and large turbochargers) similar to Embodiment 2 is mounted on an engine, and this condition can be represented by “εₑ=−0.67×V+15.0” because of reasons described later (the unit of the total displacement V is L (liter)). To be specific, regarding the diesel engine including the two-stage turbocharger, when the effective compression ratio εₑ is set to a value on the straight line L1 (−0.67×V+15.0) or larger, the combustion stability required practically can be secured, and the fuel can be ignited even under a severe condition, such as during a no-load operation (idling operation) under a cold condition.

Further, the straight line L2 set slightly above the straight line L1 in FIG. 11 shows a lower limit of the effective compression ratio εₑ capable of securing the combustion stability in a case where a single variable geometry turbocharger (single VGT) similar to Embodiment 1 is mounted on an engine, and this condition can be represented by “εₑ=−0.67×V+15.2” because of reasons described later (the unit of the total displacement V is L (liter)). To be specific, regarding the diesel engine including the variable geometry turbocharger, when the effective compression ratio εₑ is set to a value on the straight line L2 (−0.67×V+15.2) or larger, the combustion stability required practically can be secured.

Furthermore, the straight line L3 set at an uppermost side in FIG. 11 shows an upper limit of the effective compression ratio εₑ for suppressing the amount of NOx generated by the combustion to such a low level that the NOx catalyst can be omitted, and this condition can be represented by “εₑ=14.8.” To be specific, when the effective compression ratio εₑ is 14.8 or less, the combustion temperature can be prevented from increasing to such a temperature that a large amount of NOx is generated, and the NOx catalyst can be omitted.

In FIG. 11, the region X is a region defined between the straight line L1 and the straight line L3, and the region Y is a region defined between the straight line L2 and the straight line L3. These regions X and Y are represented by Inequalities (2) and (1) below, respectively.

Inequality representing Region X

−0.67×V+15.0≦εₑ≦14.8 (2)

Inequality representing Region Y

−0.67×V+15.2≦εₑ≦14.8 (1)

The range of the region X represented by Inequality (2) shows the condition of the effective compression ratio εₑ that the diesel engine on which the two-stage turbocharger is mounted should satisfy, and the range of the region Y represented by Inequality (1) shows the condition of the effective compression ratio εₑ that the diesel engine on which the variable geometry turbocharger is mounted should satisfy. To be specific, in the case of the diesel engine on which the two-stage turbocharger is mounted, the effective compression ratio εₑ is set so as to satisfy Inequality (2) (i.e., the effective compression ratio εₑ is set within the region X). With this, both the securing of the combustion stability and the omission of the NOx catalyst can be realized. In the case of the diesel engine on which the variable geometry turbocharger is mounted, the effective compression ratio εₑ is set so as to satisfy Inequality (1) (i.e., the effective compression ratio εₑ is set within the region Y). With this, both the securing of the combustion stability and the omission of the NOx catalyst can be realized.

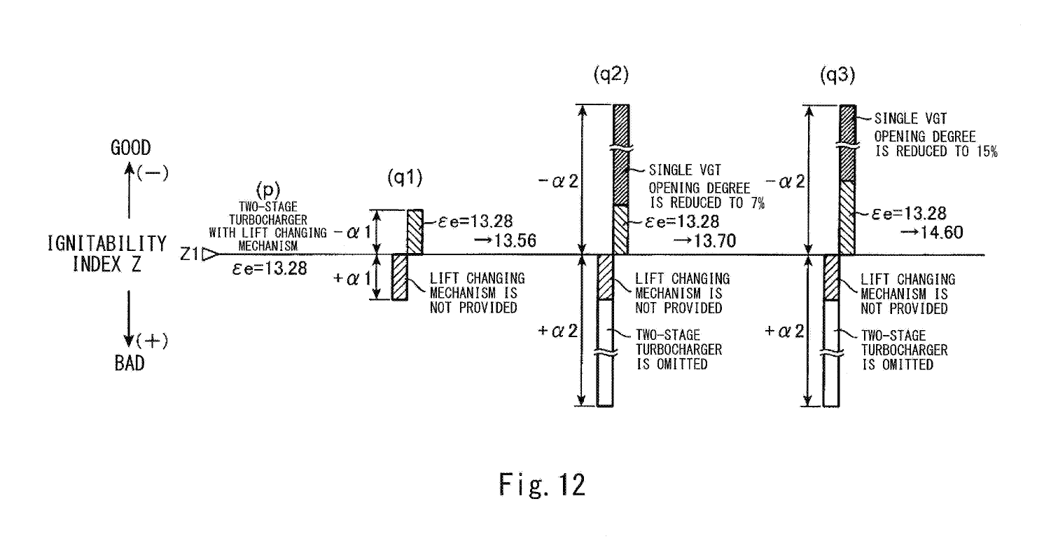

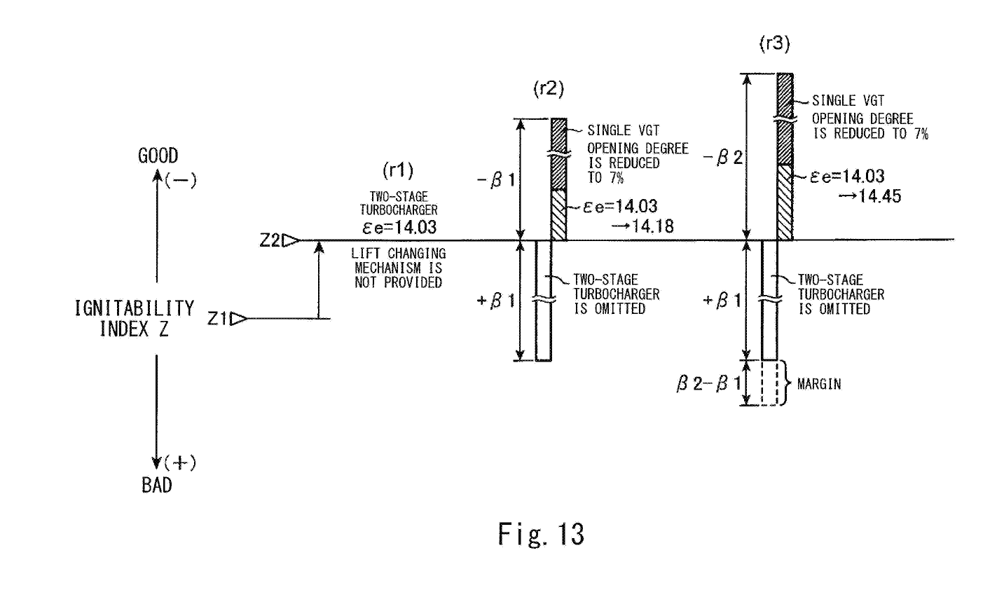

FIGS. 12 and 13 are schematic diagrams for simply explaining a study done by the present inventors for deriving the above conclusions. In this study, from the viewpoint of whether or not the fuel can be surely ignited, the cylinder internal circumstance was studied under conditions that are (i) a no-load state in which the accelerator opening degree is zero, (ii) an engine revolution speed of 2,000 rpm, (iii) an outside air temperature of −25° C., (iv) an intake temperature of −10° C., and (v) an altitude of 3,000 m.

In this study, first, the concept of “ignitability index” is introduced. The ignitability index denotes an index showing how much the cylinder internal circumstance is advantageous for the ignition of the fuel and is a value closely related to a time (ignition delay) from when the fuel injection is started until when the ignition of the fuel is started. To be specific, the smaller the ignitability index is, the shorter the ignition delay becomes, and as a result, the cylinder internal circumstance which is advantageous for the ignition is realized.

When the ignitability index is shown by Z, Z is represented by Formula (5) below.

Z=A×P_{TDC}^{B}×exp(1/T_{TDC})C×NE^{D}×CCLD^{E} (5)

In Formula (5), P_{TDC} denotes the cylinder internal pressure at the compression top dead center when the combustion is not performed, T_{TDC} denotes a cylinder internal temperature at the compression top dead center when the combustion is not performed, NE denotes the engine revolution speed, and CCLD denotes a cylinder internal oxygen concentration (i.e., oxygen concentration before the combustion). Further, A, B, C, D, and E are constants. Among these constants, A, C, and D are positive values, and B and E are negative values. Therefore, as the cylinder internal pressure, the cylinder internal temperature, and the cylinder internal oxygen concentration increase, the ignitability index Z becomes smaller (i.e., the ignition delay becomes shorter). Further, as the engine revolution speed increases, the ignitability index Z becomes larger (i.e., the ignition delay becomes longer).

The applicant of the present application has already put on the market the diesel engine whose compression ratios are set to be considerably low, and it has already been confirmed that the ignitability of such diesel engine (hereinafter referred to as a “preceding engine”) is secured even under the severe circumstance explained by the above (i) to (v). Thus, the present inventors have studied conditions for securing the ignitability similar to the above by using this preceding engine as a departure point.

Specifically, the above preceding engine put on the market by the applicant is a four-cylinder diesel engine having the total displacement of 2.2 L (2,188 cc) and the effective compression ratio of 13.28 and includes the two-stage turbocharger. Further, the preceding engine includes a lift changing mechanism configured to switch whether to open the exhaust valve again during an intake stroke. In the engine low-load region including the no-load state, to realize internal EGR in which the exhaust gas is made to remain in the cylinder, the exhaust valve is opened again by the lift changing mechanism during the intake stroke. With this, the cylinder internal temperature is increased (the ignitability is improved).

The graph of FIG. 11 shows the preceding engine as a plot p. According to the preceding engine, the internal EGR is performed in the low-load region as described above. Since the ignitability is improved by the internal EGR, the effective compression ratio εₑ can be further reduced. Therefore, the effective compression ratio εₑ of the plot p showing the preceding engine is located lower than the region X.

First, the present inventors have calculated the ignitability index Z of the preceding engine, shown by the plot p, under the severe circumstance of the above (i) to (v), and the obtained value is denoted by Z1. When the ignitability index Z of an engine having the total displacement of 2.2 L is Z1, the same ignitability as the preceding engine can be secured. Under such presupposition, the present inventors have assumed that the lift changing mechanism for performing the internal EGR is omitted from the 2.2 L engine and have studied conditions by which the same ignitability index Z1 as the preceding engine can be obtained even when the lift changing mechanism is omitted. As a result, the present inventors have obtained findings that when the effective compression ratio εₑ is increased from 13.28 of the preceding engine to 13.56, the ignitability index Z becomes the same value (Z1) as the preceding engine. To be specific, as shown by a bar graph of (q1) in FIG. 12, when the effective compression ratio εₑ is increased to 13.56, the improvement of the ignitability balances the ignitability deterioration caused by the omission of the lift changing mechanism (each of the increase and decrease of the ignitability index Z is α1). As a result, the ignitability index Z is maintained at the same value (Z1) as the preceding engine.

The above result is shown by a plot q1 in FIG. 11. To be specific, the engine shown by the plot q1 is a diesel engine having the effective compression ratio εₑ of 13.56, including the two-stage turbocharger, not including the lift changing mechanism, and having the total displacement of 2.2 L. Embodiment 2 embodies the diesel engine shown by the plot q1.

Further, the present inventors have assumed that in addition to the omission of the lift changing mechanism from the preceding engine, the two-stage turbocharger is replaced with the single variable geometry turbocharger (single VGT), and have studied the condition of the effective compression ratio εₑ necessary for that. Then, the present inventors have obtained findings that the ignitability index Z becomes the same value (Z1) as the preceding engine by increasing the effective compression ratio εₑ from 13.28 to 13.70 and reducing the vane opening degree of the variable vane mechanism to 7%. To be specific, as shown by a bar graph of (q2) in FIG. 12, in a case where the effective compression ratio is increased to 13.70, and the vane opening degree of the variable geometry turbocharger can be controlled so as to be reduced to 7%, the improvement of the ignitability thereby balances the ignitability deterioration caused by the omission of the lift changing mechanism and the omission of the two-stage turbocharger (each of the increase and decrease of the ignitability index Z becomes α2). As a result, the ignitability index Z is maintained at the same value (Z1) as the preceding engine.

The above result is shown by a plot q2 in FIG. 11. To be specific, the engine shown by the plot q2 is a diesel engine having the effective compression ratio εₑ of 13.70, including the single variable geometry turbocharger capable of reducing the vane opening degree to 7%, not including the lift changing mechanism, and having the total displacement of 2.2 L.

To reduce the vane opening degree to 7%, the performance of the driving system configured to drive the nozzle vanes needs to be considerably high. Therefore, the present inventors have assumed that the minimum value of the vane opening degree is set to be slightly higher and have studied the condition of the effective compression ratio εₑ necessary for that. Then, the present inventors have obtained findings that when the effective compression ratio εₑ is increased to 14.60, the same ignitability as the preceding engine can be obtained even if the minimum value of the vane opening degree is 15%. To be specific, as shown by a bar graph of (q3) in FIG. 12, since the effective compression ratio εₑ is increased to 14.60, the improvement of the ignitability in total becomes the same as that of the plot q2 (α2) even if the minimum value of the vane opening degree is 15%. As a result, the ignitability index Z is maintained at the same value (Z1) as the preceding engine.

The above result is shown by a plot q3 in FIG. 11. To be specific, the engine shown by the plot q3 is a diesel engine having the effective compression ratio εₑ of 14.60, including the single variable geometry turbocharger capable of reducing the vane opening degree to 15%, not including the lift changing mechanism, and having the total displacement of 2.2 L.

Next, the present inventors have studied to realize a diesel engine which has the different total displacement from the engines shown by the plots q1 to q3 but has the same ignitability as the engines shown by the plots q1 to q3. Specifically, the present inventors have assumed that the total displacement is 1.5 L and have calculated the ignitability index Z necessary in such case. When the total displacement is reduced from 2.2 L to 1.5 L, the amount of fuel injected decreases, so that a local equivalent ratio in the cylinder decreases. This means that the ignition delay becomes longer unless the circumstance advantageous for the ignition is realized in the cylinder. From this point of view, the present inventors have variously studied and found out the ignitability index Z by which the ignition delay of the 1.5 L engine becomes the same as that of the 2.2 L engine, and the obtained value is denoted by Z2. As shown in FIG. 13, the target ignitability index Z2 of the 1.5 L engine is smaller in value than the ignitability index Z1 of the 2.2 L engine.

First, the present inventors have studied the condition of the effective compression ratio εₑ by which the ignitability index Z of the 1.5 L diesel engine including the same two-stage turbocharger as the engine shown by the plot q1 becomes Z2. As a result, the present inventors have obtained findings that the ignitability index Z becomes Z2 by setting the effective compression ratio εₑ to 14.03.

The above result is shown by a plot r1 in FIG. 11. To be specific, the engine shown by the plot r1 is a diesel engine having the effective compression ratio εₑ of 14.03, including the two-stage turbocharger, not including the lift changing mechanism, and having the total displacement of 1.5 L.

Further, the present inventors have assumed that in the engine of the plot r1, the two-stage turbocharger is replaced with the single variable geometry turbocharger (single VGT), and have studied the condition of the effective compression ratio εₑ necessary for that. Then, the present inventors have obtained findings that the ignitability index Z becomes the same value (Z2) as the engine of the plot r1 by increasing the effective compression ratio εₑ from 14.03 to 14.18 and reducing the vane opening degree of the variable vane mechanism to 7%. To be specific, as shown by a bar graph of (r2) in FIG. 13, in a case where the effective compression ratio is increased to 14.18, and the vane opening degree of the variable geometry turbocharger can be controlled so as to be reduced to 7%, the improvement of the ignitability thereby balances the ignitability deterioration caused by the omission of the two-stage turbocharger (each of the increase and decrease of the ignitability index Z becomes β1). As a result, the ignitability index Z is maintained at the same value (Z2) as the engine shown by the plot r1.

The above result is shown by a plot r2 in FIG. 11. To be specific, the engine shown by the plot r2 is a diesel engine having the effective compression ratio εₑ of 14.18, including the single variable geometry turbocharger capable of reducing the vane opening degree to 7%, not including the lift changing mechanism, and having the total displacement of 1.5 L.

Further, a plot r3 located above the plot r2 in FIG. 11 shows an engine in which the effective compression ratio εₑ is made higher than that of the plot r2 for the purpose of further improving the ignitability.

Specifically, the engine shown by the plot r3 is a diesel engine having the effective compression ratio εₑ of 14.45, the single variable geometry turbocharger capable of reducing the vane opening degree to 7%, not including the lift changing mechanism, and having the total displacement of 1.5 L. Embodiment 1 embodies the diesel engine shown by the plot r3.

According to this engine, by increasing the effective compression ratio εₑ to 14.45, as shown in FIG. 13, the improvement of the ignitability increases from β1 to β2, and as a result, the ignitability index is further improved from the engine of the plot r2 by (β2−β1).

The present inventors have assumed that as with the plot q3, the minimum value of the vane opening degree of the variable geometry turbocharger of the 1.5 L engine is increased to 15%, and have studied the effective compression ratio εₑ necessary in such case. As a result, the present inventors have found that the necessary effective compression ratio εₑ is 15.07. However, the value “15.07” cannot be adopted since it exceeds 14.8 (straight line L3) that is the upper limit of the effective compression ratio εₑ when NOx is taken into consideration.

As above, the present inventors have conducted studies in order that each of diesel engines of different displacements, each of which has the same ignitability (combustion stability capable of performing ignition even in a cold and no-load state) as the already-developed preceding diesel engine, is realized by a simple configuration in which the valve changing mechanism for increasing the amount of internal EGR is omitted. As a result, the present inventors have obtained six possibilities shown by the plots q1 to q3 and r1 to r3 in FIG. 11. Then, the above straight line L1 (εₑ=0.67×V+15.0) is obtained by coupling the plots q1 and r1 each of which is assumed to include the two-stage turbocharger, and the above straight line L2 (εₑ=−0.67×V+15.2) is obtained by coupling the plots q2 and r2 each of which is assumed to include the variable geometry turbocharger capable of reducing the vane opening degree to 7%. In addition to this, the upper limit of the effective compression ratio εₑ by which the amount of NOx generated by the combustion can be reduced to such a level that the NOx catalyst can be omitted is determined, and with this, the straight line L3 (εₑ=14.8) is obtained.

Then, the following conclusion is obtained from the above result.

According to the diesel engine including the two-stage turbocharger, both the securing of the combustion stability and the omission of the NOx catalyst can be realized by setting the effective compression ratio εₑ within the range represented by Inequality (2) “−0.67×V+15.0≦εₑ≦14.8” using the function of the total displacement V, that is, within the region X of FIG. 11.

Further, according to the diesel engine including the variable geometry turbocharger capable of reducing the vane opening degree to 7%, both the securing of the combustion stability and the omission of the NOx catalyst can be realized by setting the effective compression ratio εₑ within the range represented by Inequality (1) “−0.67×V+15.2≦εₑ≦14.8” using the function of the total displacement V, that is, within the region Y of FIG. 11.

According to an engine in which the intake valve close timing cannot be changed like Embodiments 1 and 2, the effective compression ratio εₑ is always constant. However, according to an engine including a changing mechanism such as an intake VVT (mechanism configured to change the open and close timings of the intake valve), the effective compression ratio εₑ is not constant. Even in this case, the necessary combustion stability can be secured by causing the effective compression ratio at least during the no-load operation to satisfy the condition (Inequality (1) or (2)) of FIG. 11. In other words, according to the engine capable of changing the intake valve close timing, as long as the effective compression ratio during the no-load operation satisfies the condition of FIG. 11, the effective compression ratio during the other operating condition may be lower than the condition of FIG. 11.

Further, each of Embodiments 1 and 2 has explained the four-cylinder diesel engine. However, as is clear from the above details of the studies, even in diesel engines other than the four-cylinder diesel engine, the diesel engines having the same characteristics (effects) as above can be produced in such a manner that the effective compression ratio satisfying the condition of FIG. 11 is specified based on the total displacement.

Further, in the above explanation, the condition for adopting the effective compression ratio εₑ on the straight line L2 (εₑ=−0.67×V+15.2) that is the lower limit of the region Y of FIG. 11 is that the engine includes the variable geometry turbocharger capable of reducing the vane opening degree to 7%. However, if the vane opening degree can be reduced to at least less than 10%, the slight ignitability deterioration corresponding to a value obtained by subtracting 7% from less than 10% can be compensated by, for example, the other means for improving the ignitability. Therefore, the adequate ignition stability that can bear a practical use can be secured.

### LIST OF REFERENCE CHARACTERS

1 engine main body

2 cylinder

4 piston

4a crown surface

10 cavity

18 intake valve

19 exhaust valve

20 injector (injection device)

30 intake passage

40 exhaust passage

60 turbocharger

61 compressor

62 turbine

67 nozzle vane

80 small turbocharger

81 compressor

82 turbine

90 large turbocharger

91 compressor

92 turbine

1. A diesel engine configured to combust a fuel by self-ignition, the fuel being injected from an injection device into a cylinder, the diesel engine comprising a turbocharger,
the turbocharger comprising:
a turbine provided on an exhaust passage so as to be rotatable;
a compressor provided on an intake passage so as to be rotatable in conjunction with the turbine; and
a plurality of nozzle vanes provided around the turbine to control a flow velocity of an exhaust gas colliding with the turbine, angles of the nozzle vanes being changeable, wherein
in a case where a ratio of a volume of a combustion chamber when an intake valve is closed to a volume of the combustion chamber when a piston is located at a top dead center is denoted by an effective compression ratio εₑ, and a total displacement of the engine is denoted by V (L), the effective compression ratio εₑ is set to satisfy Formula (1) “−0.67×V+15.2≦εₑ≦14.8.”

2. The diesel engine according to claim 1, wherein the turbocharger is configured such that in a case where an opening degree of the nozzle vane when the adjacent nozzle vanes are closed to contact each other is regarded as 0%, and the opening degree of the nozzle vane when the nozzle vanes are opened at maximum is regarded as 100%, the opening degree of the nozzle vane is allowed to be reduced to less than 10% at minimum during an operation of the engine.

3. The diesel engine according to claim 1, wherein:
a concave cavity is formed on a crown surface of the piston, the crown surface opposing to the injection device; and
in at least a low-load operation region including a no-load state, the injection device injects the fuel, while dividing the fuel in plural parts, at such timings that at least a part of a spray of the fuel is stored in the cavity.

4. The diesel engine according to claim 2, wherein:
a concave cavity is formed on a crown surface of the piston, the crown surface opposing to the injection device; and
in at least a low-load operation region including a no-load state, the injection device injects the fuel, while dividing the fuel in plural parts, at such timings that at least a part of a spray of the fuel is stored in the cavity.

5. The diesel engine according to claim 1, wherein a close timing of the exhaust valve is set to an advance side of 10° CA after a top dead center.

6. A diesel engine configured to combust a fuel by self-ignition, the fuel being injected from an injection device into a cylinder,
the diesel engine comprising:
a small turbocharger including
a turbine provided on an exhaust passage so as to be rotatable and
a compressor provided on an intake passage so as to be rotatable in conjunction with the turbine; and
a large turbocharger including
a turbine provided on the exhaust passage so as to be rotatable, the turbine being larger than the turbine of the small turbocharger and
a compressor provided on the intake passage so as to be rotatable in conjunction with the turbine of the large turbocharger, the compressor being larger than the compressor of the small turbocharger, wherein
in a case where a ratio of a volume of a combustion chamber when an intake valve is closed to a volume of the combustion chamber when a piston is located at a top dead center is denoted by an effective compression ratio εₑ, and a total displacement of the engine is denoted by V (L), the effective compression ratio εₑ is set to satisfy Formula (2) “−0.67×V+15.0≦εₑ≦14.8.”

7. The diesel engine according to claim 6, wherein:
a concave cavity is formed on a crown surface of the piston, the crown surface opposing to the injection device; and
in at least a low-load operation region including a no-load state, the injection device injects the fuel, while dividing the fuel in plural parts, at such timings that at least a part of a spray of the fuel is stored in the cavity.

8. The diesel engine according to claim 6, wherein a close timing of the exhaust valve is set to an advance side of 10° CA after a top dead center.

9. The diesel engine according to claim 2, wherein a close timing of the exhaust valve is set to an advance side of 10° CA after a top dead center.

10. The diesel engine according to claim 3, wherein a close timing of the exhaust valve is set to an advance side of 10° CA after a top dead center.

11. The diesel engine according to claim 4, wherein a close timing of the exhaust valve is set to an advance side of 10° CA after a top dead center.

12. The diesel engine according to claim 7, wherein a close timing of the exhaust valve is set to an advance side of 10° CA after a top dead center.
